(19) United States
(12) Patent Application Publication
(10) Pub. No.: US 2016/0014077 A1
(43) Pub. Date: Jan. 14, 2016

(54) System, Method and Process for Mitigating Advanced and Targeted Attacks with Authentication Error Injection

(71) Applicants: Idan PLOTNIK, Savion (IL); Tal Arieh BE'ERY, Petach Tikva (IL); Michael DOLINSKY, Netanya (IL); Ohad PLOTNIK, Savyon (IL)

(72) Inventors: Idan PLOTNIK, Savion (IL); Tal Arieh BE'ERY, Petach Tikva (IL); Michael DOLINSKY, Netanya (IL); Ohad PLOTNIK, Savyon (IL)

(73) Assignee: Aorato Ltd., Herzliya (IL)

(21) Appl. No.: 14/327,596

(22) Filed: Jul. 10, 2014

(51) Int. Cl. H04L 29/06

(52) U.S. Cl. CPC H04L 63/0209; H04L 63/1441; H04L 63/10

(57) ABSTRACT

A method system and computer program product for protecting Directory Services (DS) by monitoring traffic to the DS; deciding to block a client access request in the monitored traffic originating from a network client; synthesizing an error message based at least in part on the client access request; and sending the synthesized error message to the network client, causing the network client to abort access request process such as an authentication process or an authorization process.

### FIELD AND BACKGROUND OF THE INVENTION

The present invention relates to cyber security and, more particularly, to a system, method and process for detecting and mitigating attacks against the authentication process in general and against the Kerberos Authentication Protocol in particular.

Kerberos is an Authentication protocol, standardized and maintained by the IETF (mainly in RFC 4120¹) and implemented by many Operating Systems (OS), including but not limited to Windows, Linux and Mac OSX. The Kerberos authentication protocol enables the transparent Single Sign On (SSO) experience. The SSO enables users to actively authenticate (i.e. provide a password) only once even though the same user accesses various services—whether in the corporate network or in the Cloud. With SSO, the Kerberos ticket is translated into SAML (Security Assertion Markup Language) tokens.

FIG. 1 is a prior art block diagram of the Kerberos Authentication protocol. FIG. 2 is a prior art block diagram of the flow of detailed messages in the Kerberos protocol. The Kerberos Authentication protocol works in the following manner:

In step 1, the user or principle provides the Domain Name, user and password in order to access the computer.

In step 2 the computer requests authentication from the Authentication Server (AS) residing on the Key Domain Controller (KDC). Accordingly, the KDC provides the computer with a Ticket Granting Ticket (TGT). The TGT is an identifier which enables the computer to request access to services without the user having to re-submit credentials.

In step 3, each time the computer attempts to access a service, the computer first identifies itself to the KDC, with the TGT that was provided earlier by the AS. The KDC provides the user with a ticket for the particular requested service. The ticket is provided by the Ticket Granting Server (TGS) of the KDC.

In step 4 the user provides the service ticket to the service. Since the ticket was validated by the TGS, the service grants authorization. Accordingly, the connection between the user and the service is established.

For each of the request-response pairs detailed in steps 2 and 3 of FIG. 1 and in more detail in FIG. 2, the KDC may choose to abort the process by replying with an error message to the client request (AS_REQ/TGS_REQ) instead of the expected response (AS_REP/TGS_REP).

### SUMMARY OF THE INVENTION

According to the present invention there is provided a Security Device (SD) for monitoring authentication and authorization on a network Directory Services (DS) environment, the security device including: (a) a Behavioral Monitoring Module (BMM), configured to monitor traffic between network clients and the DS; (b) a Dynamic Decision module (DDM), configured (manually or automatically, e.g. through an automatic learning process) to decide whether to block a client access request (for authentication or authorization) from a network client, the client access request being monitored by the BMM; (c) an error message fabrication module, configured to synthesize an error message when a blocking decision has been made by the DDM; and (d) a network interface, configured to send the synthesized error message to the network client that sent the client access request for which the DDM made the blocking decision.

According to further features in preferred embodiments of the invention described below the error message is a Kerberos error message.

According to still further features in the described preferred embodiments the BMM passively monitors the traffic.

According to still further features in the described preferred embodiments the security device is interposed between the network clients and the DS, such that the security device is capable of blocking requests from the network clients to all services on the DS.

According to still further features in the described preferred embodiments the BMM is configured to monitor traffic between the network clients and a Key Domain Controller.

According to still further features in the described preferred embodiments the DDM makes decisions based on logic selected from the group including: local logic, remote logic and a combination of both remote and local logic.

According to still further features in the described preferred embodiments the error message fabrication module extracts at least some parameters for at least some mandatory fields of the synthesized error message from the client access request.

According to still further features in the described preferred embodiments the network interface is configured to further send a TCP termination message to the DS, causing the DS to terminate a TCP connection between the DS and the network client.

According to another embodiment there is provided a method of protecting Directory Services (DS), the method including the steps of: (a) monitoring traffic to the DS; (b) deciding to block a client access request in the monitored traffic originating from a network client; (c) synthesizing an error message based at least in part on the client access request; and (d) sending the synthesized error message to the network client, causing the network client to abort an access request process. The access request process may be an authentication process or an authorization process.

According to further features the monitored traffic is Kerberos traffic and the synthesized error message is a Kerberos error message.

According to still further features in the described preferred embodiments the client access request is intended for a Key Domain Controller (KDC).

According to still further features in the described preferred embodiments the decision made in step (b) is based on logic selected from the group including: local logic, remote logic and a combination of both remote and local logic.

According to still further features in the described preferred embodiments the traffic is monitored in a non-invasive manner.

According to still further features in the described preferred embodiments the traffic is monitored by a network entity residing in a traffic path between the network client and the DS.

According to still further features in the described preferred embodiments the network entity resides in the traffic path between all network clients and the DS and configured to block access of any the network clients to the DS.

According to still further features in the described preferred embodiments at least some parameters for at least some mandatory fields of the error message are extracted from the client access request.

According to still further features in the described preferred embodiments the method further includes the step of (e) sending a TCP termination message to the DS, causing the DS to terminate a TCP connection between the DS and the network client.

According to another embodiment, there is provided a non-transient computer readable medium storing computer readable code that upon execution of the code by a computer processor, causes the computer processor to: (a) monitoring traffic to the DS; (b) deciding to block a client access request in the monitored traffic originating from a network client; (c) synthesizing an error message based at least in part on the client access request; and (d) sending the synthesized error message to the network client, causing the network client to abort an access request process. The access request process may be an authentication process or an authorization process.

The present invention discloses an innovative passive Security Device (SD), monitoring Kerberos traffic is able to detect attacks against the authentication system. To mitigate the attacks in a real-time manner, the SD can act on the behalf of the intended receiver and inject an error message that would terminate the malicious transaction.

The SD thus acts as a compensating security control to the authentication system's own security controls, as the SD can enforce security policies independent of the authentication system policies. As such, the SD operator can add security policies with no changes to the authentication system configuration. The security policies themselves can be based on behavioral and contextual rules, algorithms and knowledge that are not available to the authentication system.

It is important to note that the SD does not necessarily need to be placed within the traffic flow path in an intrusive manner that would require all traffic to first flow through the SD, thus making it a part of the critical network chain. Rather, the device can passively monitor a copy of the traffic (e.g. with port mirroring, tap device or NetFlow) and selectively interfere with only relevant Kerberos Authentication and Authorization connections that are identified as malicious.

### BRIEF DESCRIPTION OF THE DRAWINGS

Various embodiments are herein described, by way of example only, with reference to the accompanying drawings, wherein:

FIG. 1 is a prior art block diagram of the Kerberos Authentication protocol;

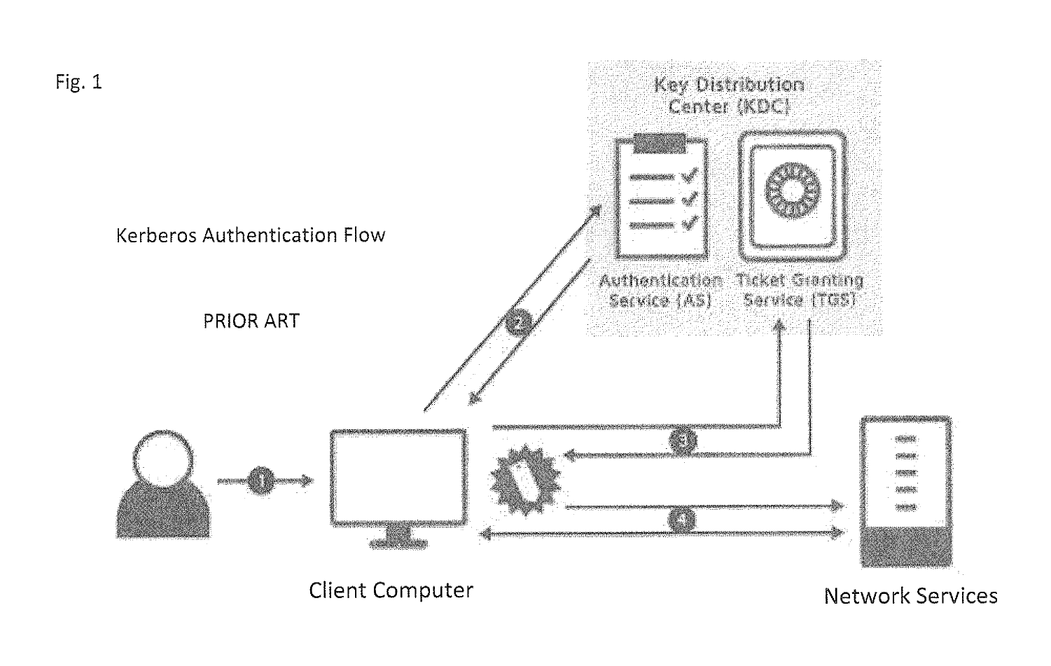

FIG. 2 is a prior art block diagram of the flow of detailed messages in the Kerberos protocol;

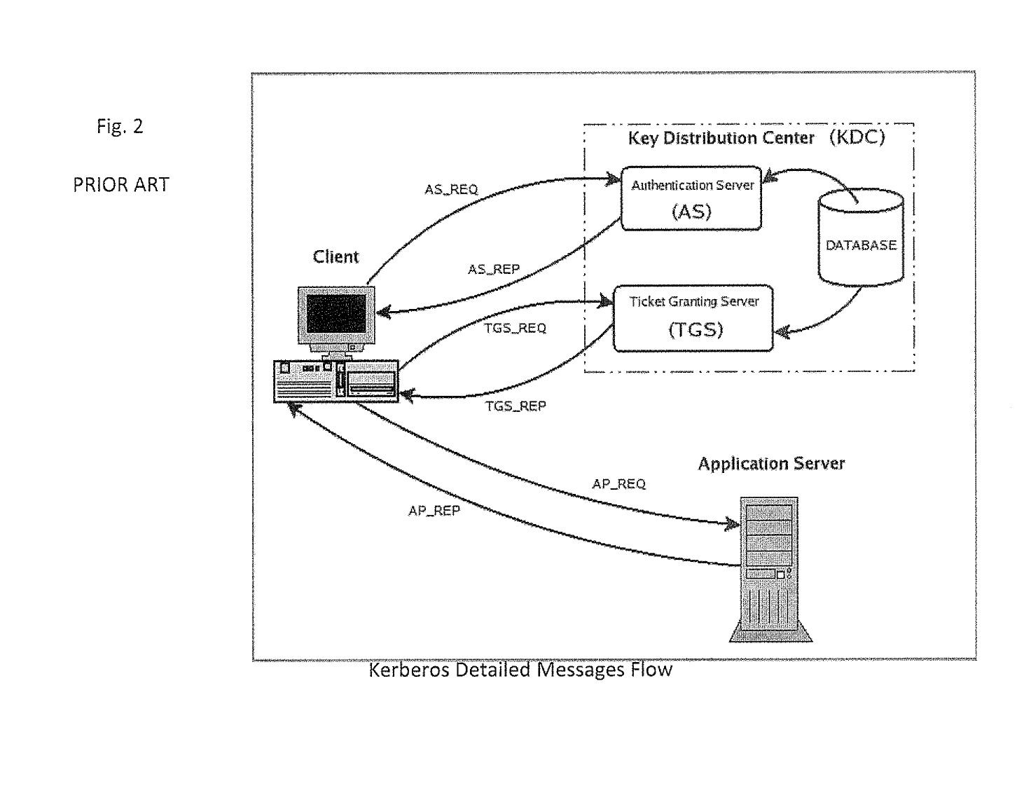

FIG. 3 is a high level flow chart of the security device (SD) operation;

FIG. 4 is a flow diagram of an exemplary error message fabrication process of the immediate invention;

FIG. 5 is a block diagram of a first configuration of an exemplary system wherein the SD is deployed as an In-Line device;

FIG. 6 is a block diagram that illustrates a second configuration of an exemplary system wherein the SD is deployed as an Out-Of-Line;

FIG. 7 is a block diagram of an exemplary computer device;

FIG. 8 is a block diagram of an exemplary implementation of the SD on an exemplary computing device

### DESCRIPTION OF THE PREFERRED EMBODIMENTS

The principles and operation of a Security Device (SD) according to the present invention may be better understood with reference to the drawings and the accompanying description.

The present invention is adapted to be implemented in a networked Directory Services environment (e.g. a cloud based network environment or a local network environment). A prominent example of a Directory Services (DS) implementation is the Active Directory (AD) service for Windows network. The Active Directory (AD) service implements the KDC. Therefore, DS, KDC and AD are used interchangeably throughout this document.

In one embodiment, the present invention discloses an innovative, non-intrusive Security Device (SD) that monitors Kerberos traffic and is able to detect attacks against the authentication system. The SD can either monitor the traffic passively in a non-inline (out-of-line) mode/configuration or in an inline mode/configuration. To mitigate the attacks in a real-time manner, the SD can act on the behalf of the intended receiver and inject an error message that would terminate the malicious transaction.

Generating a Kerberos Error Message

In order for the SD to generate and send a valid Kerberos error message on behalf of the KDC that will be accepted by the client as valid, the SD must be able to generate a valid and credible message at all of the relevant protocol message layers:
Application layer: Kerberos
Transport layer: TCP or UDP (i.e. the transport layer may be TCP or UDP)
Network layer: IP
Data link layer: Ethernet for most cases, but also any other data link protocol including Wireless LAN

The SD is able to independently generate a response message based solely on the receipt of a valid request message since none of the aforementioned layers apply cryptographic protection to the integrity of the messages. Generating a valid message on the Transport, Network and Data link layers based on receipt of a client transport message is known in the art (sometimes referred to as “response spoofing”), and is therefore only briefly discussed here, in a manner to sufficient to instruct one of ordinary skill in the art. On the other hand, generation of the application layer part of the message is discussed in greater detail.

Generating a Valid Kerberos Error Payload

Application Layer

One reason why a device which is not the KDC can generate an error message on behalf of the KDC is that this message integrity is not cryptographically protected.

According to the Kerberos RFC, The KRB_ERROR message consists of the following mandatory fields (optional fields are omitted):
pvno: The Protocol Version Number. For current Kerberos implementation this value will always be “5”, but to maintain generality it can be determined from the client request.
msg-type: Error message type is always 30.
slime: The current server time in the Kerberos time format. Example:

The only valid format for UTC time 6 minutes, 27 seconds after 9 pm on 6 Nov. 1985 is 198511062106272.
susec: This field contains the microsecond part of the current time of the server clock.
error-code: The desired error code. See Appendix A for a list of all possible values.
realm: This is the realm of the KDC that the security device is protecting. The realm can be determined from the client request.
sname: The KDC service name. For errors the sname will always be the “Krbtgt” service name, but to maintain generality the sname can be determined from the client request.

A valid third party Kerberos error message can therefore be synthesized by fabricating, at least, the mandatory fields of the error message which are either fixed, well known, can be determined from the client request or are arbitrary.

Transport Layer

For both TCP and UDP the port numbers are taken from the client request. Checksum and header length fields are calculated according to the payload data.

TCP Specific

TCP is a connection-oriented protocol that keeps message order with sequence numbers. The sequence numbers should be updated accordingly. The “seq” field is taken, from the “ack” field and the “ack” field is calculated by adding the TCP payload length to the received “seq” field. For an example see Appendix B. Furthermore, it is preferable to terminate the connection. The connection is terminated by setting the RST (reset) TCP flag.

Network Layer

IP address data is taken from the client request. Checksum and header length fields are calculated according to the payload data For an example see Appendix B.

Data Link Layer

MAC address data is taken from the client request. Checksum and header length fields are calculated according to the payload data. For an example see Appendix B.

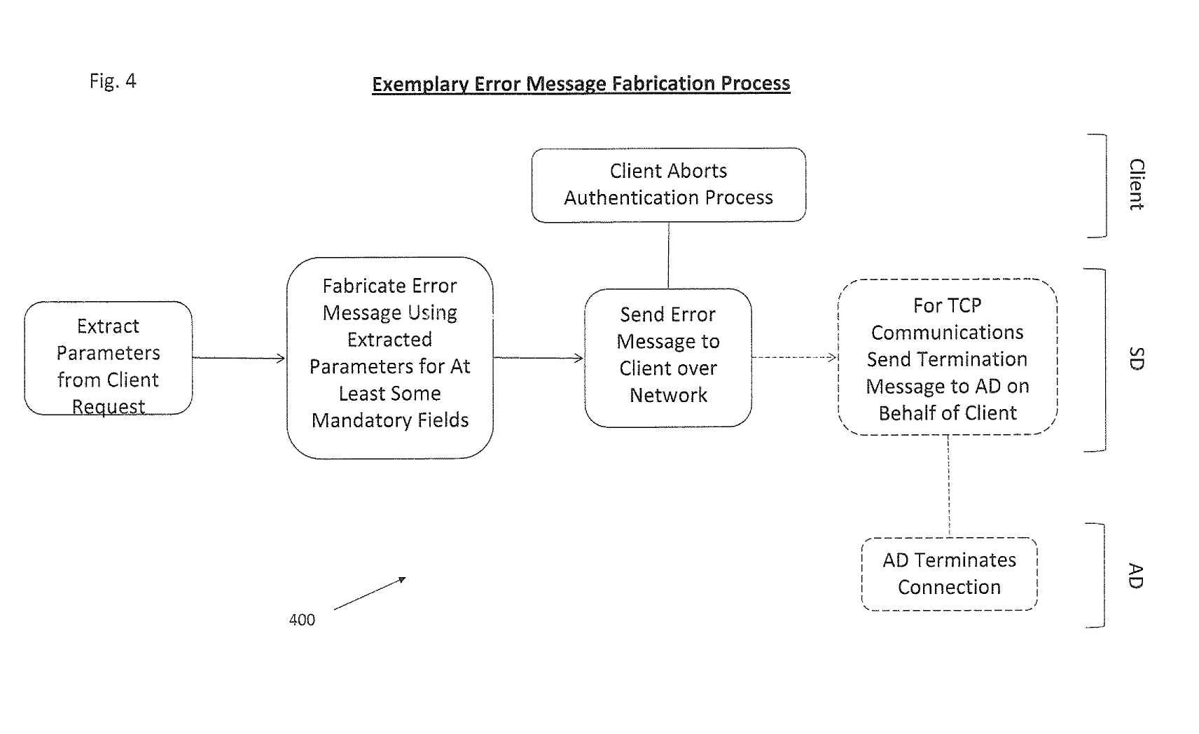

Response spoofing is generally used by hackers and other dubious characters for nefarious purposes. Innovatively, the fabricated error message is used for security purposes, to protect the target system. One possible technical difference may be that a hacker may not be careful to make a clean termination of the communication and therefore would not send a terminating message to the AD, but only to the client. By contrast, the innovative system tries to ensure smooth and correct functioning of the overall network and therefore sends a termination message to the AD/DS as well (see Step 408 in FIG. 4).

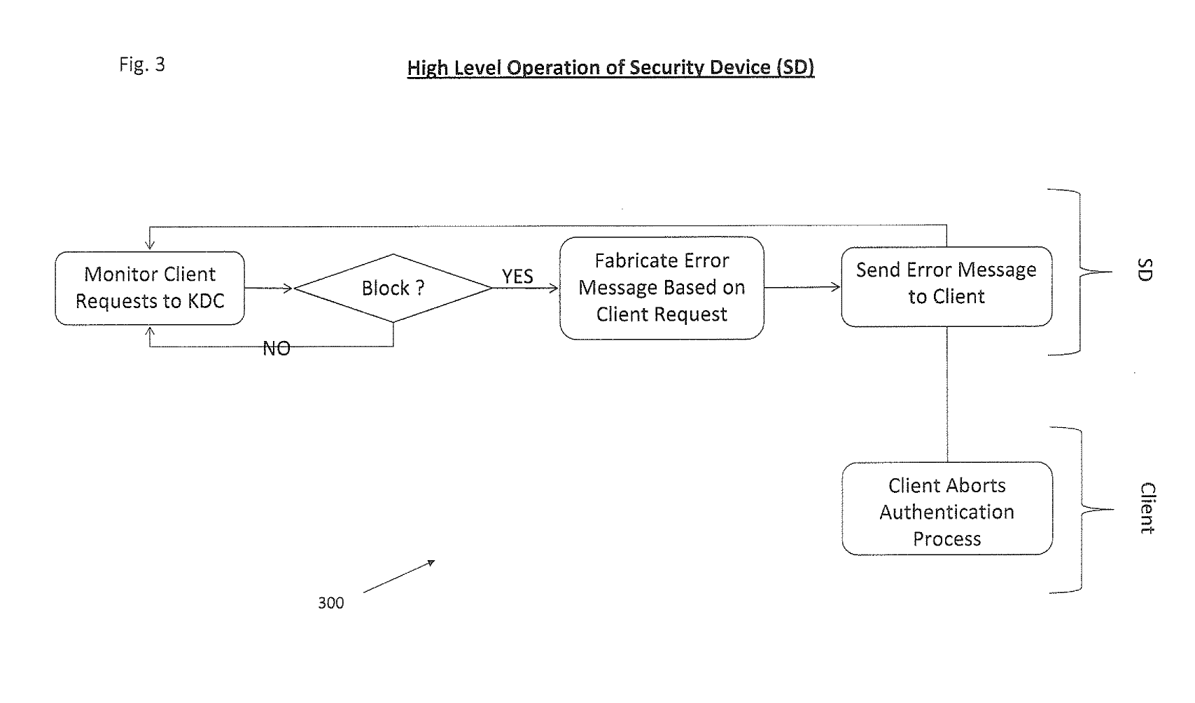

FIG. 3 is a high level flow chart of the security device (SD) operation. Flow 300 describers the high level process of the SD. In step 302 the SD monitors client requests to the KDC. The SD can be implemented in the system in one of two configurations, either as an inline device or an out of line device. See below for a discussion regarding each configuration.

In step 304 the SD decides whether to block a request or not. The decision process can be based on the data in the client request or some other information. The decision may be based on internal/local logic and/or external/remote logic (e.g. the SD receives instructions to block a specific client request from some other security entity that has determined that the client request is malicious). The process (logic) for determining whether a client request should be blocked, or should not to blocked, may include an analysis of the behavior of the client entity which sent the request. The particular logic that determines which requests should be blocked and which should be allowed is beyond the scope of the immediate invention. If the SD does not decide to block the request, then the SD does nothing proactive and continues to monitor subsequent client requests (i.e. go to step 302).

If the SD decides to block a user from accessing the domain (block the AS_REQ message) or a certain resource within the domain (TGS_REQ message), then in step 306 the SD synthesizes or fabricates an error message based on the client request that the SD is trying to block.

In step 308, the SD sends the error message to the client. The SD continues to monitor subsequent client requests (i.e. go to step 302). In step 310 the client aborts the authentication process in response/reaction to the fabricated error message (strictly speaking, step 310 is not part of the SD operation process, but rather the result of the final step of the SD process). The authentication process includes the process of the client (network client) presenting credentials to the authentication server for authentication.

FIG. 4 is a flow diagram of an exemplary error message fabrication process of the immediate invention. Flow 400 depicts the high level steps of the fabrication process employs in some exemplary embodiments. In step 402 the SD extracts the required parameters needed to complete at least the mandatory fields of the new error message. See above the discussion under the header GENERATING A VALID KERBEROS ERROR PAYLOAD.

In step 404 the SD creates a Kerberos error message, specially suited to the client request that the SD has decided to block, (in step 304 of FIG. 3) based on the parameters and the relevant error to be sent, as specified above.

In step 406 the error message is sent to the client over the network. As a result of receiving the error message, the client aborts the authentication process. In the inline mode the TCP connection is a two-way communication between client and AD. One direction of the communication (AD to client) is terminated with the sending of the Kerberos error with the relevant TCP flag. To close the other direction (client to AD) the SD sends a message on behalf of the client with no application layer data, just the relevant TCP flag. In embodiments with two-way TCP communication, a TCP termination message is sent, in step 408, to the Active Directory on behalf of the client. As a result of receiving the message, the AD terminates the connection (i.e. the connection is terminated from the Active Directory side).

Security Device Deployment Modes

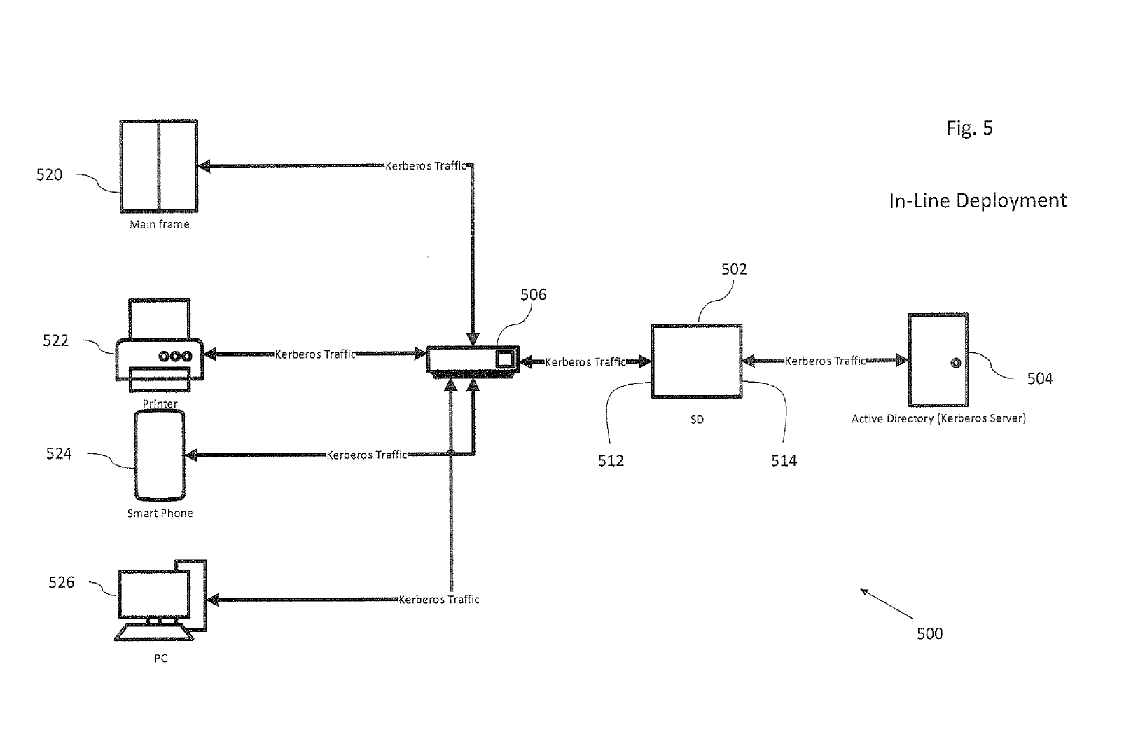

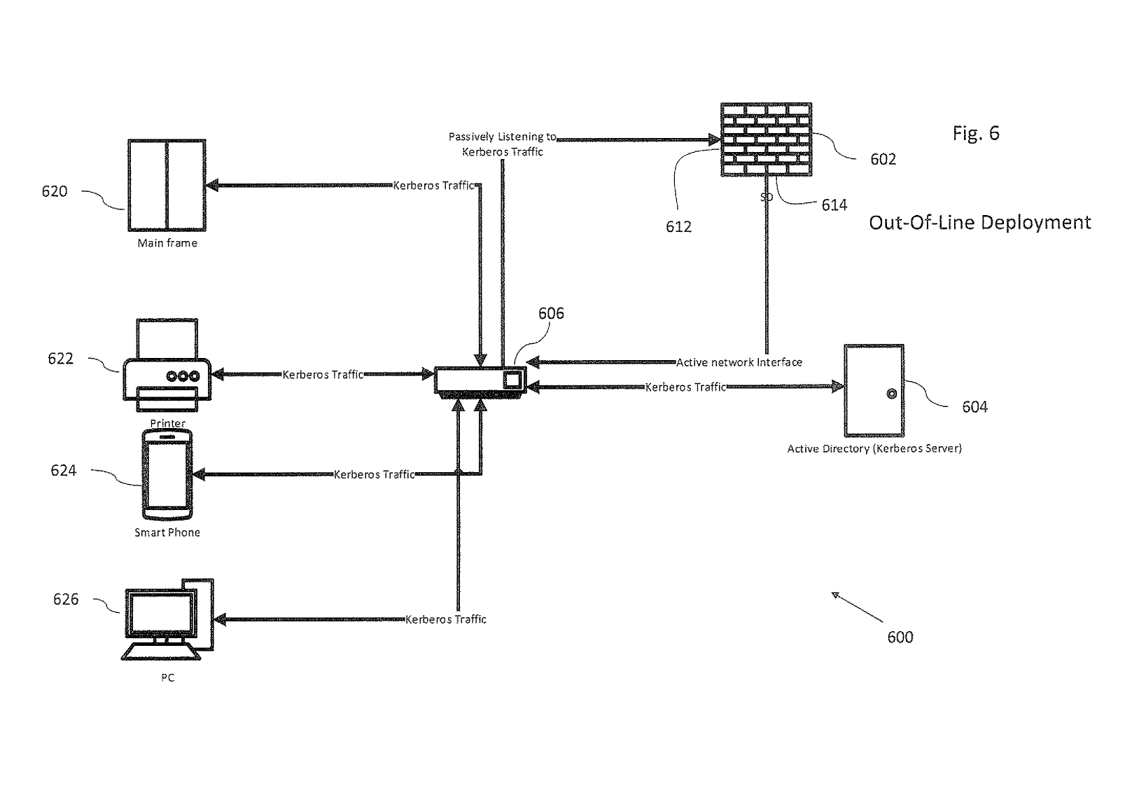

The security device can be deployed either as an In-line device or as an Out-of-Line device. The merits of each deployment mode are discussed below. FIG. 5 is a block diagram that illustrates a first configuration of an exemplary system wherein the SD is deployed as an In-Line (also written ‘Inline’, ‘inline’ and variations thereof) device. FIG. 6 is a block diagram that illustrates a second configuration of an exemplary system wherein the SD is deployed as an Out-Of-Line (also written ‘out of line’, ‘out-of-line’ and variations thereof) device.

An example of the Inline Deployment Mode is depicted in the block diagram of FIG. 5. In the depicted exemplary system 500, a security device (SD) 502 is positioned between a client and an Active Directory 504. As a result, the SD has two network interfaces: a client-facing network interface 512 and an AD-facing network interface 514. In the figure a number of exemplary clients are depicted. The depicted exemplary clients are a mainframe 520, a printer 522, a smartphone 524, and a PC 526. As mentioned, the depicted clients are merely exemplary, and not intended to be limiting in any way. In the figure, an exemplary switch 506 is positioned between the AD and the clients.

During normal operation the SD monitors and forwards packets from one network interface to the other. When the SD receives a client request message that needs to be blocked, the SD does not forward the request message to the AD, but instead crafts an error message and sends the message to the client over the client facing interface. In the case of a TCP connection, the SD also sends a TCP termination message over the AD facing interface.

An example of the Out-of-Line Deployment Mode is depicted in the block diagram of FIG. 6. In the depicted exemplary system 600, a security device 602 is connected to a switch 606 that switches the Active Directory traffic (including Kerberos traffic) and has two network interfaces: a [passive/non-intrusive] monitoring network interface 612—receiving all incoming and outgoing traffic to an AD 604 and an active network interface 614—for sending out packets. In the figure a number of exemplary clients are depicted. The depicted exemplary clients are a mainframe 620, a printer 622, a smartphone 624, and a PC 626. As mentioned, the depicted clients are merely exemplary, and not intended to be limiting in any way.

During normal operation SD 602 passively monitors AD traffic. When the SD receives a client request message and determines that the message needs to be blocked, the SD 602 crafts and sends an error message to the client on the active network interface 614 and sends a TCP termination message on the active network interface 614, in case of a TCP connection.

In the Out-of-Line mode, SD 602 cannot prevent the request that needs to be blocked from reaching AD 604. As a result both the AD 604 and SD 602 send reply messages. The client accepts the first response that arrives and ignores the second. Therefore, the SD reply must arrive first for the blocking to occur. The SD is likely to succeed in sending a reply message before the AD sends one, as the SD has less computational overhead than the AD in constructing a response. The SD error message is comprised mainly of predetermined values and is not encrypted (as discussed above).

In contrast, the AD message is client specific: the message is encrypted with a client specific key and contains some client specific values such as the client privileges. Some of the aforementioned data needs to be obtained from the AD 604 which incurs an additional delay. Additionally, some parts of the AD message are cryptographically encrypted and signed, which also adds a delay. Therefore it is most likely that the ‘fake’ error message will reach the client first, before the ‘real’ response from the AD, effectively stopping the client request message from effecting any changes.

Comparison of Inline VS. Out of Line Deployment Modes

In the Inline deployment mode/architecture, the SD is situated between the clients and the AD, in the message path. As a result, all of the inbound and outbound traffic to and from the AD must flow through the SD. Consequently, an SD that is deployed in an inline mode can drop a request message that needs to be blocked before the message even reaches the AD and therefore has (almost) no time constraints for crafting a reply. By contrast, in the Out-of-Line deployment mode, the SD cannot stop a request message that needs to be blocked from propagating to the AD. Therefore the SD must send a fabricated reply message faster than the AD sends a reply. The SD is likely to succeed in sending an error message first, as explained above, but there is always a chance that for some reason the message from the AD arrives first. Therefore, the inline mode provides more certainty to the success of the blocking action.

On the other hand, when the SD is deployed in the Out-of-Line mode, then the SD is not part of the critical chain (traffic path). This can be positive for a number of reasons. For example, if the SD fails for some reason, the stability of the system will not be compromised. At the very least messages can still flow back and forth between the clients and the AD. By contrast, if the SD fails when deployed in the Inline mode, then the entire Kerberos system is compromised as Kerberos messages are blocked by the non-functional or malfunctioning SD. Therefore, at for the aforementioned reason, it can be said that the out-of-line mode provides better fault tolerance.

Examples of Relevant Use Cases

The following examples illustrate the usefulness of the solution provided by the immediate invention. The example are by no means the only relevant use cases, merely a sampling.

Stolen Kerberos Ticket

In the case where the security device (SD) has determined that a certain Kerberos ticket has been stolen, the SD monitors the message traffic for the stolen ticket. When the stolen ticket is used to gain access to the Active Directory (for example) with a TGS_REQ, the Security device sends a Kerberos Error Message containing the KDC_ERR_TGT_REVOKED error code and terminates the connection. The attack is thwarted and the stolen ticket is revoked.

Quarantine a User

In a case where the SD has determined that a certain user is infected with malware (or has been informed by a third party that the user is infected, for example), the SD monitors for any client requests from the infected user. If the SD receives or detects a client request from the infected to authenticate against the Active Directory, for example, with an AS_REQ, the SD sends a Kerberos Error Message containing the KDC_ERR_CLIENT_REVOKED error code and terminates the connection. The client privileges are revoked until the user is issued new credentials (e.g. after the system administrator cleans the malware off the system etc.)

Quarantine a Specific Service

In a case where the SD has determined that a certain service is infecting users with malware (for example), then all client requests to authenticate to the problematic service against the Active Directory (e.g. with a TGS_REQ) are responded to by the SD which sends a Kerberos Error Message containing the KDC_ERR_SERVICE_REVOKED error code and terminates the connection. Effectively the service is quarantined by the SD and no clients are allowed to authenticate to the malicious service.

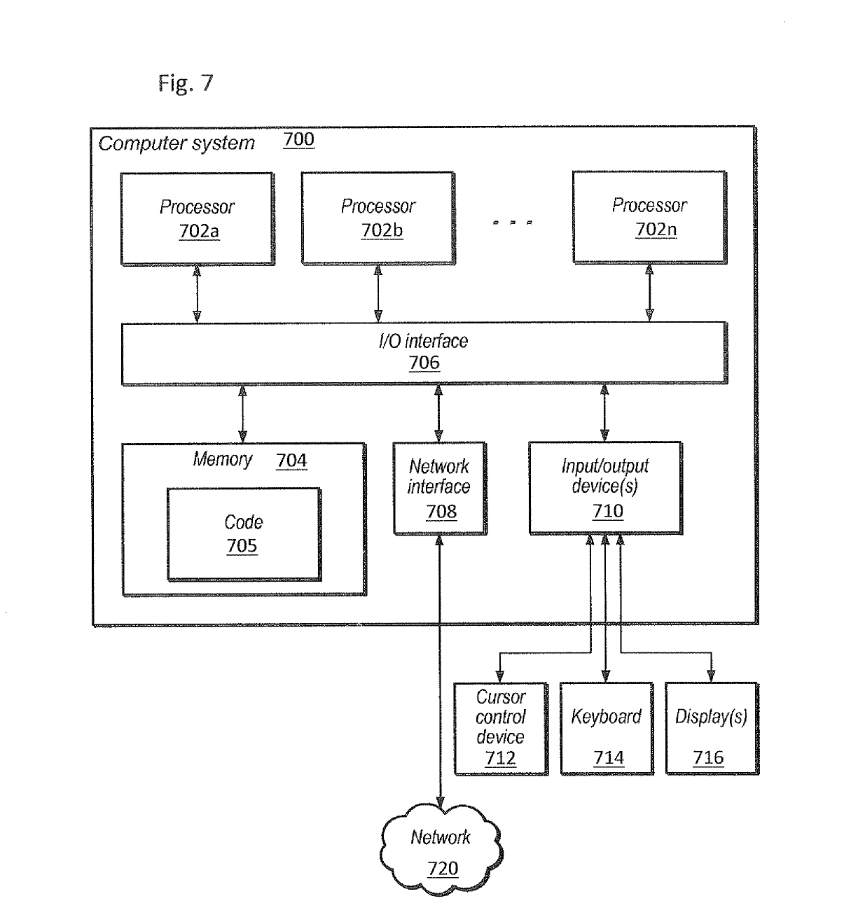

One example embodiment of a computer system including computer-accessible media is illustrated in FIG. 7. Computer system 700 may correspond to an example configuration of a computing device upon which SD 502/602 can be embodied. Correspondingly, in various embodiments, the functionality of any of the various modules or methods described above and below may be implemented by one or several instances of computer system 700.

In the illustrated embodiment, computer system 700 includes one or more processors 702 coupled to a system memory 704 via an input/output (I/O) interface 706. Computer system 700 further includes a network interface 708 coupled to I/O interface 706. In various embodiments, computer system 700 may be a uniprocessor system including one processor 702, or a multiprocessor system including several processors 702 (e.g., two, four, eight, or another suitable number). Processors 702 may be any suitable processor capable of executing instructions. For example, in various embodiments processors 702 may be a general-purpose or embedded processor implementing any of a variety of instruction set architectures (ISAs), such as the x86, PowerPC™, SPARC™, X64 or MIPS™ ISAs, or any other suitable ISA. In multiprocessor systems, each of processors 702 may commonly, but not necessarily, implement the same ISA.

System memory 704 may be configured to store instructions and data accessible by processor 702. In various embodiments, system memory 704 may be implemented using any suitable memory technology, such as static random access memory (SRAM), synchronous dynamic RAM (SDRAM), nonvolatile/Flash-type memory, or any other type of memory. In the illustrated embodiment, instructions and data implementing desired functions, methods or techniques, such as those described above and below, are shown stored within system memory 704 as code or modules 705. It is noted that in some embodiments, code/modules 705 may include instructions and data implementing desired functions that are not directly executable by processor 702 but are represented or encoded in an abstract form that is translatable to instructions that are directly executable by processor 702.

In one embodiment, I/O interface 706 may be configured to coordinate I/O traffic between processor 702, system memory 704, and any peripheral devices in the device, including network interface 708 or other peripheral interfaces. In some embodiments, I/O interface 706 may perform any necessary protocol, timing or other data transformations to convert data signals from one component (e.g., system memory 704) into a format suitable for use by another component (e.g., processor 702). In some embodiments, I/O interface 706 may include support for devices attached through various types of peripheral buses, such as a variant of the Peripheral Component Interconnect (PCI) bus standard or the Universal Serial Bus (USB) standard, for example. In some embodiments, the I/O interface 706 may be coupled to an Input/Output device interface 710. Input/output device interface may be couples to peripheral devices, such as cursor control device 712 (e.g. a mouse, pointing device etc.), a keyboard 714, one or more displays 716 and other devices known in the art. In some embodiments some or all of the functionality of I/O interface 706, such as an interface to system memory 704, may be incorporated directly into processor 702. In some embodiments some or all of the functionality of Input/output device interface 710, such as an interface to cursor control device 714, display 716, keyboard 714 may be incorporated directly into computer system 700 and controlled by processor 702 (e.g. in a touch screen device such as a smartphone or tablet computer).

Network interface 708 may be configured to allow data to be exchanged between computer system 700 and other devices attached to a network 720 (e.g. such as depicted in FIG. 5 or 6), such as other computer systems, for example. In various embodiments, network interface 708 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

In some embodiments, system memory 704 may be one embodiment of a computer-accessible/computer-readable storage medium configured to store instructions and data as described above. However, in other embodiments, instructions and/or data may be received, sent or stored upon different types of computer-accessible storage media. Generally speaking, a computer-accessible storage medium may include storage media or memory media such as magnetic or optical media, e.g., disk or CD/DVD-ROM coupled to computer system 700 via I/O interface 706. A computer-accessible storage medium may also include any volatile or non-volatile storage media such as RAM (e.g. SDRAM, DDR SDRAM, RDRAM, SRAM, etc.), ROM, etc, that may be included in some embodiments of computer system 700 as system memory 704 or another type of memory. A computer-accessible storage medium may generally be accessible via transmission media or signals such as electrical, electromagnetic, or digital signals, conveyed via a communication medium such as a network and/or a wireless link, such as may be implemented via network interface 708.

All methods described herein can be performed on one or more electronic processors and/or computers working with each other. These processors/computers can be in the same or different physical locations connected by any type of computer communications network.

All features of documents that are incorporated by reference can be combined without limitation with each other and with features described in the text fully set forth herein. Features described herein can be combined with any feature(s) in the documents incorporated by reference without limitation.

It is noted that the order of any of the operations described herein can be performed in any order. Any operation described herein can also be optional. All flowcharts herein are not intended to illustrate the only possible implementation, and modifications and deviations can be added which include any feature described herein or based on well-established principles. For example, while endless loops may be theoretically possible in some flowcharts, in reality such situations could be handled using common sense approaches. Any embodiments herein can also be stored in electronic form and programs and/or data for such can be stored on any type of computer readable storage medium (e.g. CD-ROM, DVD, disk, etc.)

The descriptions provided herein also include any hardware and/or software known in the art and needed to implement the operations described herein. All components illustrated herein may also optionally communicate with any other component (either illustrated/described herein or not described but known in the art).

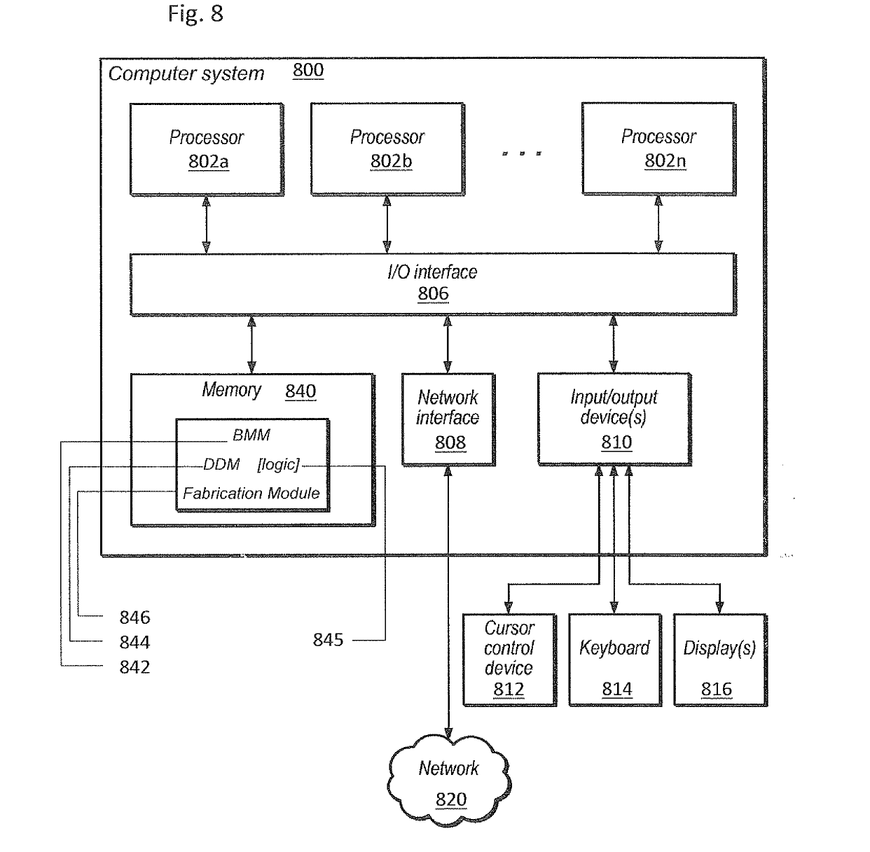

FIG. 8 is a block diagram of an exemplary implementation of the SD on an exemplary computing device 800. Exemplarily, computing device 800 is substantially similar to computing device 700 described above. The SD may be a computing device and/or a network entity on the network. The SD is configured to monitor authentication on a network/AD environment 820. In some embodiments, the SD monitors the Kerberos Authentication Protocol. The SD may be in the traffic path between network clients and the AD or only monitor the traffic there-between.

In some embodiments, the SD includes a Behavioral Monitoring Module (BMM) 842 stored on a non-transient computer readable storage medium 840 (one or more, collocated or remote, etc. as is known in the art) in communication with a processor 802 (one or more, collocated or remote, etc. as is known in the art). The BMM 842 monitors the network traffic between the clients (network clients) and the AD (e.g. see FIG. 5 or 6). In some embodiments, the BMM monitors client access requests to the KDC.

In some embodiments, the SD further includes a Dynamic Decision Module (DDM) 844 which is also stored on storage medium 840, or on a different storage medium. The DDM 844 decides whether the SD must block a particular client authentication request. The DDM may be configured manually or automatically (e.g. through an automatic learning process) to decide whether to block a client access request from a network client. The client access request may be a request for authentication or it may be a request for authorization. If the blocking module determines that a request must be blocked then the module issues a ‘blocking decision’, i.e. instructions to block a particular request. In some embodiments of the invention, the DDM includes decision logic 845 (also referred to as ‘local logic’ or ‘internal logic’ for residing locally/internally on the SD) for deciding whether a particular access request must be denied or not. In other embodiments the DDM receives instructions to block a particular request (or requests from a particular client or requests for access to a particular service on the AD etc.) from an external/remote source (e.g. a separate security mechanism). In the aforementioned cases, the DDM makes a determination based on external/remote logic. In still other embodiments, a determination of whether to block a request or not is made based on both local and remote logic.

The phrase “block a request” and its variations (used both here and above) are not intended to necessarily describe the method of dealing with a suspicious authentication request but rather the overall result, whereby the authentication request is blocked/denied/rejected/prevented from gaining authentication. As described above, the SD injects an error message into the network traffic causing the connection to be broken. The SD, at least in out-of-line mode, does not actually prevent the request message from reaching the AD but rather injects an error message before the client can be authenticated.

In some embodiments, the SD includes an Error Message Fabrication Module 846, stored in storage device 840, which fabricates/synthesizes the aforementioned error messages. When the DDM issues a blocking decision/instructions to block a request, the fabrication module synthesizes a error message to ‘block’ the request. As described above in greater detail, the fabrication module extracts various data/parameters from the client request for the fabrication process. The module uses the extracted parameters, together with other information gleaned from the network and sundry arbitrary parameters to create a ‘fake’ error message. In some embodiments, the error message is a Kerberos error message.

In some embodiments, a Network Interface 808, injects the error messages into the traffic stream of network 820. Exemplarily, the network interface may be in communication with processor 802 either directly or via an I/O interface 806. The network interface is adapted to send a fabricated error message to the client, once the fabrication module has prepared/synthesized the error message. In some embodiments, the network interface is further adapted to send a termination message to the AD/DS to terminate the connection (by setting the RST (reset) TCP flag).

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A security device (SD) for monitoring authentication and authorization on a network Directory Services (DS) environment, the security device comprising:
(a) a Behavioral Monitoring Module (BMM), configured to monitor traffic between network clients and the DS;
(b) a Dynamic Decision Module (DDM), configured to decide whether to block a client access request from a network client, said client access request being monitored by said BMM;
(c) an error message fabrication module, configured to synthesize an error message when a blocking decision has been made by said DDM; and
(d) a network interface, configured to send said synthesized error message to said network client that sent said client access request for which said DDM made said blocking decision.

2. The security device of claim 1, wherein said error message is a Kerberos error message.

3. The security device of claim 1, wherein said BMM passively monitors said traffic.

4. The security device of claim 1, wherein the security device is interposed between said network clients and said DS, such that the security device is capable of blocking requests from said network clients to all services on said DS.

5. The security device of claim 1, wherein said BMM is configured to monitor traffic between said network clients and a Key Domain Controller.

6. The security device of claim 1, wherein said DDM makes decisions based on logic selected from the group including: local logic, remote logic and a combination of both said remote and local logic.

7. The security device of claim 1, wherein said error message fabrication module extracts at least some parameters for at least some mandatory fields of said synthesized error message from said client access request.

8. The security device of claim 1, wherein said network interface is configured to further send a TCP termination message to said DS, causing said DS to terminate a TCP connection between said DS and said network client.

9. A method of protecting Directory Services (DS), the method comprising the steps of:
(a) monitoring traffic to the DS;
(b) deciding to block a client access request in said monitored traffic originating from a network client;
(c) synthesizing an error message based at least in part on said client access request; and
(d) sending said synthesized error message to said network client, causing said network client to abort an access request process.

10. The method of claim 9, wherein said monitored traffic is Kerberos traffic and said synthesized error message is a Kerberos error message.

11. The method of claim 9, wherein said client access request is intended for a Key Domain Controller (KDC).

12. The method of claim 9, wherein said decision made in step (b) is based on logic selected from the group including: local logic, remote logic and a combination of both remote and local logic.

13. The method of claim 9, wherein said traffic is monitored in a non-invasive manner.

14. The method of claim 9, wherein said traffic is monitored by a network entity residing in a traffic path between said network client and the DS.

15. The method of claim 14, wherein said network entity resides in said traffic path between all network clients and the DS and configured to block access of any said network clients to the DS.

16. The method of claim 9, wherein at least some parameters for at least some mandatory fields of said error message are extracted from said client access request.

17. The method of claim 9, further comprising the step of:
(e) sending a TCP termination message to the DS, causing the DS to terminate a TCP connection between the DS and said network client.

18. A non-transient computer readable medium storing computer readable code that upon execution of the code by a computer processor, causes the computer processor to:
(a) monitor traffic to Directory Services (DS);
(b) decide to block a client access request in said monitored traffic originating from a network client;
(c) synthesizing an error message based at least in part on said client access request; and
(d) sending said synthesized error message to said network client, causing said network client to abort an access request process.
